(19) United States
(12) Patent Application Publication
(10) Pub. No.: US 2019/0164387 A1
(43) Pub. Date: May 30, 2019

(54) NO-BUST, PLAYER VERSUS PLAYER BLACKJACK GAMING EVENT

(71) Applicant: Vinko Dobrosevic, Coral Gables, FL (US)

(72) Inventor: Vinko Dobrosevic, Coral Gables, FL (US)

(21) Appl. No.: 15/827,420

(22) Filed: Nov. 30, 2017

(51) Int. Cl. G07F 17/32; A63F 1/00

(52) U.S. Cl. CPC G07F 17/3293; G07F 17/3258; G07F 17/3279; A63F 1/00; G07F 17/323; G07F 17/3213; A63F 2001/005; A63F 2001/001; G07F 17/3216; G07F 17/322; A63F 2001/003

(57) ABSTRACT

A method and systems enable executing of game content in a player-versus-player(s) point count game using community playing cards or non-community playing cards. A target maximum point count is defined, initial playing card symbol hands of 1-2 playing card symbols is provided to each player position, and then an order defined sequence of cards is provided. A winner among the players has a final point count closest to the target maximum without exceeding it, and ties in final point counts are broken by a better hand having better poker rank or more total cards used in forming a player's final point count total hand. Wagering events with players placing value at risk in execution of the game may also be made.

### BACKGROUND OF THE INVENTION

### 1. Field of the Invention

The present invention relates to the field of gaming, including social gaming, online gaming for value, electronic gaming machines (EGMs), electronic gaming tables, physical live gaming tables, physical live gaming tables with video feed, and any other available format, especially using gaming events using physical or virtual playing cards.

### 2. Background of the Art

Poker games have been an increasing basis of the casino and on-line gaming field over the past twenty years. Poker has been commercially provided in a number of successful formats including a) casino tables with a house dealer and the casino taking a rake or commission during play; b) player versus dealer wagering events (e.g., Three-Card Poker™ games, Four-Card poker games, Caribbean Stud Poker™ game, Ultimate Texas Hold'Em™ poker and the like); c) electronic gaming machine (EGM) player versus a paytable; d) live table games with a video feed to off-the table on-line wagering players; and e) direct player-versus player(s) on-line wagering with virtual playing cards provided by a random number generator. These gaming technologies have achieved varying degrees of success, primarily dependent upon the attractiveness of the underlying games themselves. It is therefore desirable to be able to provide new game content that will attract additional game players.

### SUMMARY OF THE INVENTION

A method in live or virtual formats executes a wagering event in a player versus player wagering event supported by a non-wagering third party. At least one standard randomized deck of playing cards (or possibly modified decks of playing cards) are provided, the method possibly including:
a) providing at least one randomized deck of playing cards;
b) at least two player positions placing value at risk as an ante or blind or both wager in a player-versus-player competition into a community pot on an outcome of a wagering event in which I) the at least two player positions are provided with random playing cards at respective player positions and II) in a stream of community cards in an attempt to collect point counts at the respective player positions closest to a point count of 21 without exceeding a point count of 21;
c) providing at least one random playing card from the at least one randomized deck of playing cards to each of the at least two player positions having placed value at risk as an ante wager;
d) each of the at least two player positions making a first play wager into the community pot to continue play at the at least two player positions;
e) if only one player position makes the first play wager or any subsequent play wager, that one player collects the community pot;
f) if multiple ones of the at least two player positions make the first play wager, then an ordered number of random playing cards is provided from the at least one randomized deck of playing cards to a community card location in a position order of at least a first playing card, a second playing card, and a third playing card until a specific predetermined number of random playing cards have been provided or the point count total of all exposed playing cards in the community card location equals or exceeds a point count total of 19;
g) point count totals in each of the at least two player positions are determined according to a specific point count procedure consisting of totaling count points for all cards in respective ones of the at least two player positions and then adding point counts from individual ones of the playing cards in the community card location or individual location in their position order up to a maximum point count total of 21 or less without exceeding a total point count of 21;
h) each of the at least two player positions comparing respective point count totals at respective player positions;
i) determining which respective player position has a point count total closest to 21 without exceeding 21; and
   then awarding the community pot to that respective player position that has a point count total closest to 21 without exceeding 21.

Similarly, as in the real poker games there will be version of the game that does not require community cards. Instead each player receives additional cards to their own initial two, three or four cards. Good examples are traditional STUD games. In Seven Card Stud, a player receives 7 cards total with 2 cards down and 5 cards up. The same will apply to Stud21 or Five card Stud21 where each individual player will receive 5 or 7 cards total.

### BRIEF DESCRIPTION OF THE FIGURES

FIG. 1A shows a schematic for an electronic system for enabling play of the gaming method described herein.

FIG. 1B shows another schematic for an electronic system for enabling play of the gaming method described herein.

FIG. 1C shows an electronic gaming machine on which the gaming method may be executed.

### DETAILED DESCRIPTION OF THE INVENTION

A method and various systems are provided for use in live or virtual (electronic based) formats for executing a wagering event in a player versus player wagering event supported by a non-wagering third party (the house, casino, internet provider, website and the like). At least one standard randomized deck of playing cards (or possibly modified one or more decks of playing cards) are provided. The method possibly includes:
a) providing at least one randomized deck of playing cards;
b) at least two player positions placing value at risk as an ante wager in a player-versus-player competition into a community pot on an outcome of a wagering event in which I) the at least two player positions are provided with random playing cards at respective player positions and II) in a stream of community cards or non-community cards (individual cards) in an attempt to collect point counts at the respective player positions closest to a point count of 21 without exceeding a point count of 21;
c) providing at least one random playing card from the at least one randomized deck of playing cards to each of the at least two player positions having placed value at risk as an ante wager;
d) each of the at least two player positions making a first play wager into the community pot to continue play at the at least two player positions;
e) if only one player position makes the first play wager or any subsequent play wager, that one player collects the community pot;
f) if multiple ones of the at least two player positions make the first play wager, then an ordered number of random playing cards is provided from the at least one randomized deck of playing cards to a community card location or individual player location in a position order of at least a first playing card, a second playing card, and a third playing card until a specific predetermined number of random playing cards have been provided or the point count total of all exposed playing cards in the community card location equals or exceeds a point count total of 19;
g) point count totals in each of the at least two player positions are determined according to a specific point count procedure consisting of totaling count points for all cards in respective ones of the at least two player positions and then adding point counts from individual ones of the playing cards in the community card location in their position order up to a maximum point count total of 21 or less, without exceeding a total point count of 21;
h) each of the at least two player positions comparing respective point count totals at respective player positions;
i) determining which respective player position has a point count total closest to 21 without exceeding 21; and
   then awarding the community pot to that respective player position that has a point count total closest to 21 without exceeding 21.

This gaming event may also offer side bets against a paytable for various events. For example, a bet may be placed on the number of cards in a specific hand before that hand busts, the total number of cards in all hands at the table before a bust, how many cards will be used and a specific point count total of 21 (or 20 and 21) is achieved, whether a count of 21 (or 21 and 20) with all cards of the same color or suit is attained, etc.

### Play Example

Table limits will be the same as in traditional Poker. The game can be dealt on blackjack, baccarat, mini-baccarat or poker tables.

Game execution events:
The object of the game is to receive the best card combination closest to 21 without exceeding 21.
Hands Rankings
   Royal Flush (1-6 of the same suit)

### Straight 1-6

7 cards 21
6 cards 21
5 cards 21
4 cards 21
Flash 21 Beats 21 mixed
combo
678 same suit
3 cards 21 suited
777
3 cards 21 non-suited

### BlackJack

The game can be played with a single deck or multiple decks.

The dealer will shuffle the cards as outlined by individual casino procedures. Dealer or one of the players will cut the deck as outlined by the service provider (house) execution events.

In a new game, the dealer will place the DEALER button on the last box on the table. House may create its own execution events for DEALER button placement. Example some execution events require that when starting new game each player receive one card at the beginning of the game and player with the highest card gets DEALER button. If the game is in progress the dealer will place the DEALER button in front of the next player whose turn was coming before the shuffle took place. In other words, the shuffle will not interfere with the order of DEALER button movement.

Before dealing the cards, the dealer will invite players after the DEALER to place small blind and big blind. Once the blinds are placed dealer will deal two hold (facedown) cards to each player. Once the cards are received by players the game will continue with the first betting round. The player after big blind will bet first and betting will continue until all bets are called.

After this dealer will place the first community card on the board.

Second round of betting takes place.

Dealer deals second community card on the board.

Third betting round takes place

Dealer flops additional three cards in the order on the board

Fourth and final rounds of betting takes place.

Winner is a player that has the highest total without exceeding 21. Player must use order of the cards to calculate total (best hand). Player cannot bust in this game. If the one of the cards dealt exceeds total of 21, the total before that card came out will count (apply).

Poker 21 hand Example:

Below example was taken from actual poker hand using 21 execution events.

Seat 2 is the button (dealer button)

### Seat 1: (3300.25).

### Seat 2: (2000).

### Seat 3: (2210.70).

### Seat 4: 1(5224.25).

### Seat 5: (2463).

### Seat 6: (3023.61).

Player 3: has small blind (10)
Player 4: has big blind (20)
Player 3: received card: [Qc]
Player 3: received card: [10s] Total 20
Player 4: received card: [Jc]
Player 4: received card: [Kd] Total 20
Player 5: received card: [10h]
Player 5: received card: [7h] Total 17
Player 6: received card: [Qs]
Player 6: received card: [8s] Total 18
Player 1 received card: [8c]
Player 1 received card: [Js] Total 18
Player 2: received card: [Ac]
Player 2: received card: [4h] Total 5/15
Player 5: folds
Player 6: raises (50)
Player 1: folds
Player 2: folds
Player 3: calls (40)
Player 4: calls (30)
*** FIRST COMMUNITY CARD ***: [6c]
Player 3: checks
Player 4: checks
Player 6: checks
*** SECOND COMMUNITY CARD ***: [6c] [4d]
Player 3: checks
Player 4: checks
Player 6: checks
*** FLOP ***: [6c]-[4d] [3c 9d 3d]
Player 3: checks
Player 4: checks
Player 6: checks
Player 3: mucks cards
Player 6: mucks cards

### ------ Summary ------

### Pot: 147.00. Rake 3.00

Board: [6c 4d 3c 9d 3d]
Player 1: (10+8)=18 FOLDS, does not show cards.Bets: 0. Collects: 0. Wins: 0.
Player 2: (A+4+6)=21 FOLD, does not show cards.Bets: 0. Collects: 0. Wins: 0.
Player 3: (10+10)=20 mucks (does not show: [Qc 10s]). Bets: 50. Collects: 0.

### Loses: 50.

### *Player 4: (10+10)=20 [Jc Kd]. Bets: 50. Collects: 147. Wins: 97.

Player 5: (10+7)=17 FOLDS, does not show cards. Bets: 0. Collects: 0. Wins: 0.
Player 6: (10+8)=18 mucks (does not show: [Qs 8s]). Bets: 50. Collects: 0. Loses: 50.

If all players stayed in the game the winner would be the player number 2. The player 2 would win with 3 cards 21.

Dealer will collect all the bets in the pot and pay winner accordingly after collecting house service fee (rake) in this case $3.

### Execution Events Variations

To cover as many possibilities of the execution events pertaining to patent we COULD patent different card rankings. Instead of Blackjack being the strongest card we can patent many different variations.

### Variation One

Blackjack is the strongest hand however it is ranked by suit and high card.

Example: AK beats AQ and AK of spades beats AK of hearts.

### Variation Two

A23456 same suit ROYAL JACK (spades, hearts, diamonds, clubs)
A23456 mixed

### AK Spades

### AK Hearts

### AK Diamonds

### AK Clubs

AQ as above
AJ as above
A10 as above
777 same suits as above beats all other 21's
777 mixed
678 same suit as above
678 mixed

Here are possible rankings for Poker21:
Royal Flush (1-6 of the same suit)
Straight 1-6
7 cards 21
6 cards 21
5 cards 21
4 cards 21
Flash 21 Beats 21 mixed
combo
678 same suit
3 cards 21 suited
777
3 cards 21 non-suited
BlackJack

Example on how we could expand rankings further: KK beats QQ, KK of Spades beats KK of hearts, KQ beats K10 etc.

The above is only one of the version on how to deal the game in the casino on a live table.

Betting options:
The betting options will be the same as in traditional Holdem game
Some games like Holdem21 and Omaha21 will start with blindes while other games like stud games (Stud21) will start with ante.

Card dealing options:
Same as in traditional Hold'em poker game with the exception that the flop is reversed.
Example:
   Dealer will deal 2 cards face down to each player. The cards are dealt one at the time clockwise until each participating layer receives two cards down.
   Board cards will be as follows:
      First card up
      Second card up next to the first. If the total of the first two community cards are 19 or 20 than the dealing round is finished. If the total is below 19 than we will deal (we can call it reverse flop) additional 3 cards at the same time.
      3 cards flop will be placed on the board next to the second card. Each flop card must be placed on the board in the order as they were taken from the deck.
Alternative game execution events could be that the player with the highest score closest to 21 with the fewest cards is a winning. A blackjack by one player will end the game with that player as a winner. The pot, less a commission (e.g., ½ the ante wager, 5% of the Pot at the end of the game, possibly whichever is larger) is then awarded to the winning hand. Hence the term “less than the entire community pot” is used to described award of less than the entire community pot. In this manner, players can earn much more per hand than with standard blackjack, and the house is assured winnings. Side bets may be made in numerous fashions as described elsewhere herein. In the event of ties and where on player wins by having the preferred number (most or least) of playing cards, it is possible to apportion the community pot, as by having one player with the preferred hand number of cards winning a larger percentage (e.g., 90%, 75%, ⅔, etc.) of the community pot, while a second tied player (or more players) would win or share a lesser amount of the community pot (e.g., 10%, 25%, ⅓, etc.).

Another method of executing the wagering events within the scope of the present technology would include a method of executing a wagering event in a player versus player wagering event supported by a plurality of individual electronic gaming machines that are networked, the individual electronic gaming machines comprising individual processors, individual display screens, individual player input controls, and individual housings for the electronic gaming machines, the electronic gaming machines further comprising individual value-in-value-out credits systems for entering and withdrawing wagering value from the individual electronic gaming machines, the value-in-value-out systems comprising at least one of a ticket-in-ticket-out component that reads and prints tickets, a currency validation component that has a motor drive for accepting currency, and an eWallet reading and transmitting component, the method comprising:
a) a central processor providing at least one randomized deck of virtual playing cards;
b) at least two player positions placing value at risk through the individual player input controls as an ante wager into a community pot monitored by the central processor on an outcome of a wagering event in which the at least two player positions are provided by the central processor with random virtual playing cards at respective player positions and a stream of virtual community playing cards in an attempt to collect point counts at the respective player positions closest to a point count of 21 without exceeding a point count of 21;
c) the central processor providing at least one random virtual playing card from the at least one randomized deck of virtual playing cards to each of the at least two player positions having placed value at risk as an ante wager;
d) each of the at least two player positions making a first play wager into the community pot through the individual player input controls to continue play at the at least two player positions;
e) if only one player position makes the first play wager or any subsequent play wager, that one player position collects the community pot;
f) if multiple ones of the at least two player positions make the first play wager, then an ordered number of random virtual playing cards is provided from the at least one randomized deck of playing cards to a community virtual card location in a position order of at least a first virtual playing card, a second virtual playing card, and a third virtual playing card until a specific predetermined number of random virtual playing cards have been provided or the point count total of all exposed virtual playing cards in the community card location equals or exceeds a point count total of 19;
g) point count totals in each of the at least two player positions are determined by the central processor according to a specific point count procedure consisting of totaling count points for all virtual cards in respective ones of the at least two player positions and then adding point counts from individual ones of the virtual playing cards in the community card location in their position order up to a maximum point count total of 21 or less, without exceeding a total point count of 21;
h) the central processor comparing each of the at least two player positions respective point count totals at respective player positions;
i) the central processor determining which respective player position has a point count total closest to 21 without exceeding 21; and
j) then the central processor awarding the community pot to that respective player position that has a point count total closest to 21 without exceeding 21.

The method on the electronic gaming machines would enable the central processor to withdraw an absolute amount or a percentage amount from the community pot before awarding the community pot to a winning player position. This method would further enable the central processor to determine that there is an identical winning point count total in multiple ones of the at least two player positions, a player position which utilizes a most number of playing cards in attaining that winning point count total wins the community pot.
In the following discussion, numerous related gaming events will be referenced. One series of generic gaming concepts is herein referred to as “Poker21”™ blackjack. This is a player-to-player (P2P) version of the poker game using execution events (card rankings) of the game of Blackjack. In general, this game can be executed in at least the follow modalities:
1. Table game in land based casino;
2. Table game played online;
3. Table game played on electronic table in casino and possibly privately at home;
4. Home game played on a kitchen table; and
5. Home game played on mobile devises with TV, monitor or other devises.

One casino version of this gaming event can be executed on the traditional Blackjack (BJ) table using existing BJ layout, poker table using poker layout or even baccarat/mini baccarat table using their respective layouts. Alternatively, a casino can purchase a specifically designed Poker21™ game layout for one of gaming suppliers.

### Poker 21 Games

The initial games listed here are all poker games that use poker betting strategy and modified execution events (hands ranking) of Blackjack. The initial games are:

### Holdem 21

### Omaha 21

### Stud 21

Seven cards stud 21
Five card stud 21

### Baccarat Nine Games

### Holdem 9

### Omaha 9

### Stud 9

Seven cards stud 9
Five card stud 9

### Baccarat Nine or Baccarat 9

The variations of Baccarat 9 games are:

### Holdem 9

### Omaha 9

### Stud 9

Seven cards stud 9
Five card stud 9

Baccarat Nine is the game that is played with poker betting rounds. The hands ranking is replaced with modified Baccarat hand rankings. The object of the game is similar to Baccarat game where winner is the player who gets the highest hand using “baccarat total POINTS” with either two or three cards maximum. The picture cards and tens are counted as zero and with any total exceeding 10 or twenty the first digit dropped, and it is not counted. Example: player receives 8 and 5 and then draws 5 as a third card. The combined total is 18 or in baccarat terms 8. Six and nine (15) is five. A and 9 is zero.

### Game Dealing and Betting Rounds

To start the game each participating player will place the ANTE bet.

Dealer will deal one card face up to each player starting with the player after the dealer button.

First betting round will take place.

Dealer will deal second card face down to each player starting with the player after the dealer button.

Second betting round will start

Dealer will offer the third card to each player starting with the player seated after the dealer button.

The final round will take place.

The player with highest count of the two or three cards combination will win the hand

Drawing execution events will be defined by service provider (house). Our version calls for a liberal rule without restrictions on when the third card can be drawn. Some service providers may have execution events requiring players to stand on 9 or 8 and 9 or 7, 8, 9.

The game can be played with ANTE bet, with BLINDS or both.

the game can be dealt as STUD games where each player receives their own cards or as Holdem or Omaha games with community cards.

Example of Holdem game:

### Holdem 9

Table limits can be defined as in traditional poker. The game could start with ante as well as with blinds or combination of both.

The game could be dealt on Baccarat or Mini Baccarat table. Game could also be dealt on poker table and improvised on Blackjack table. The game can be played with 2 players or as many as 10-12 players.

To start the game the two players after the dealer button will place small and big blinds.

Dealer will deal one card to each player starting with the player with the small blind.

First betting round will take place.

Dealer will place the first board card in the middle of the table.

Second betting round will start

Dealer will place second board card on the next to the second board card

The final round will take place.

The player with highest count of the two or three cards combination will win the hand

One embodiment, described in more detail below as a “chipless gaming platform”, the gaming device includes one or more display devices that are mounted into a gaming table surface and are controlled by the processor in addition to or separately from the individual player monitors. The display devices are preferably connected to or mounted into the table structure. This may include a central display device which displays a primary game, dealer images, jackpot information, or information that is not specifically related to the game, such as sports information or winning events at other tables. This display device may also display any suitable secondary game associated with the primary game as well as information relating to the primary or secondary game (e.g., side bets, bonuses, jackpots and the like).

An alternative embodiment may include a central horizontal game display device and a vertically oriented virtual dealer display device as in Shuffle Master, Inc.'s Table Master™ gaming system. The central display device may display the primary game, any suitable secondary game associated or not associated with the primary game and/or information relating to the primary or secondary game. These display devices may also serve as digital glass operable to advertise games or other aspects of the gaming establishment. The gaming device includes a credit display 20 which displays a player's current number of credits, cash, account balance, or the equivalent. In one embodiment, the gaming device includes a bet display displays a player's amount wagered. In one embodiment, as described in more detail below, the gaming device includes a player tracking display which displays information regarding a player's play tracking status.

In yet another embodiment, at least one display device may be a mobile display device, such as a PDA or tablet PC that enables play of at least a portion of the primary or secondary game at a location remote from the gaming device. The display devices may include, without limitation, a monitor, a television display, a plasma display, a liquid crystal display (LCD) a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism.

In one embodiment, as described in more detail below, the display device includes a touch-screen with an associated touch-screen controller. The display devices may be of any suitable size and configuration, such as a square, a rectangle or an elongated rectangle. The display devices of the gaming device are configured to display at least one and preferably a plurality of game or other suitable images, symbols and indicia such as any visual representation or exhibition of the movement of objects such as mechanical, virtual, or video reels and wheels, dynamic lighting, video images, images of people, characters, places, things, faces of cards, images of dealers and the like.

Other forms of the invention are in the form of game software that is implemented in a variety of formats, such as internet gaming, PC practice play, hand-held game devices, wireless gaming devices and the like.

### Chipless Gaming Table Implementation

One enabling system useful in the practice of the present invention is the use of playing cards with Chinese domino symbols which can be distributed for use with a system marketed under the name i-TABLE™ by Shuffle Master, Inc. of Las Vegas, Nev. That system includes: a) a physical gaming table; b) player monitors at each player position; c) a playing card reading and delivery system (e.g., commercially available shufflers and playing card delivery shoes with reading capability as sold under the Trade names of One2Six™ shuffler, Ace™ shuffler, I-DEAL™ shuffler, I-SHOE™ delivery shoe, etc.); d) a processor receiving information (numbers of cards, rank of cards, suits of cards, etc.) from the card reading and delivery systems; e) communication connectivity (hardwired or wireless) between necessary combinations of the card reading/delivery systems and the processor, the processor and the individual player monitors, and/or the card reading/delivery systems and the video monitors; and f) software in the processor that defines predetermined advantage for distributions of playing cards into multiple hands, game execution events, hand history, and the like. In order to prevent a bet pattern exceeding the number of possible hands in a “live” shoe, a card count will be tracked and the remaining cards will be continually divided by six (the maximum number of cards for a hand).

With regard to software f), it is understood in the practice of the present technology that this is not complex software that reads individual player hand cards and determines advantageous card distributions for a first time by extensive calculations. Rather, the entire range of possibilities of hands (e.g., all possible five card sets dealt to players in poker-style games) is known in poker style games.

A preferable card handling device for administering a video reel-type-style game is a hand-forming shuffler with integrated card recognition technology, from which playing cards are supplied, with a least a rank/count (and preferable also suit) of individual packs of cards are known before the cards are removed and delivered to player positions and/or the banker position. The card delivery system 102 is in communication with the controller 128 by wired or wireless communication methods. Communication between the various system components is not limited to electronic or electrical signals, but may include optical signals, audio signals, magnetic transmission or the like.

The individual player position processors (not shown) are preferable graphics processors and not full content CPUs as a cost saving, space saving, and efficiency benefit. With the reduced capacity in the processor as compared to a CPU, there is actually reduced likelihood of tampering and fraudulent input.

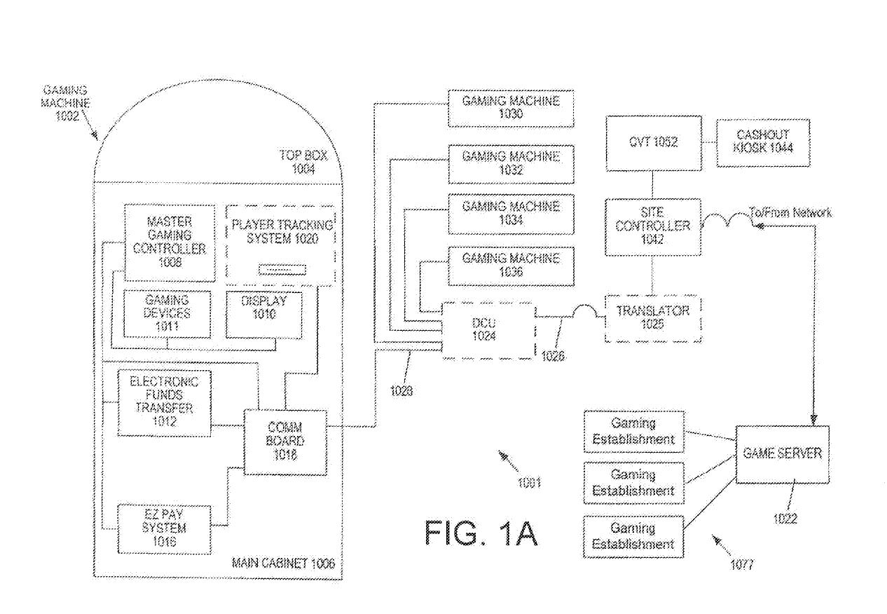

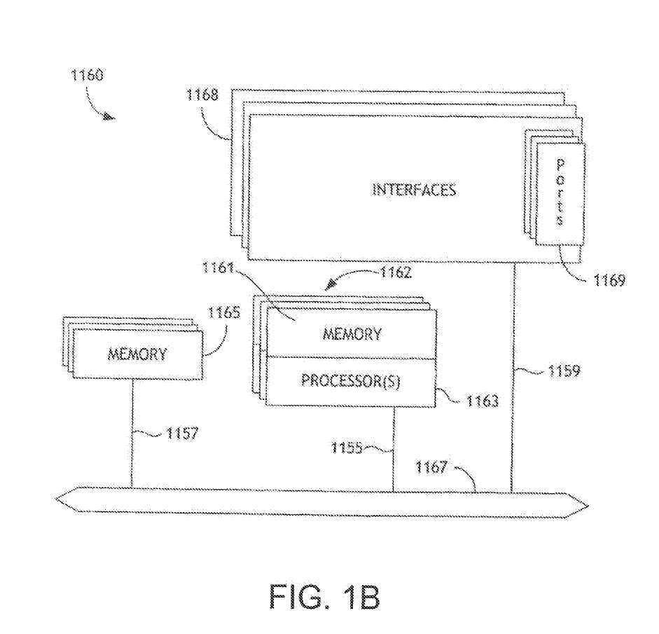

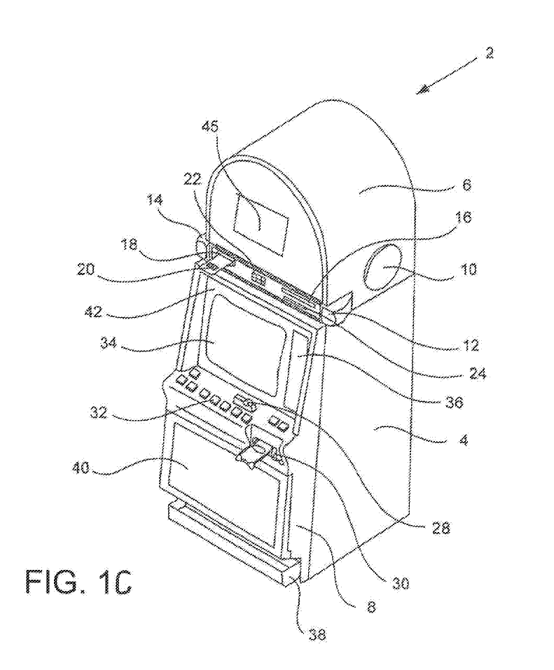

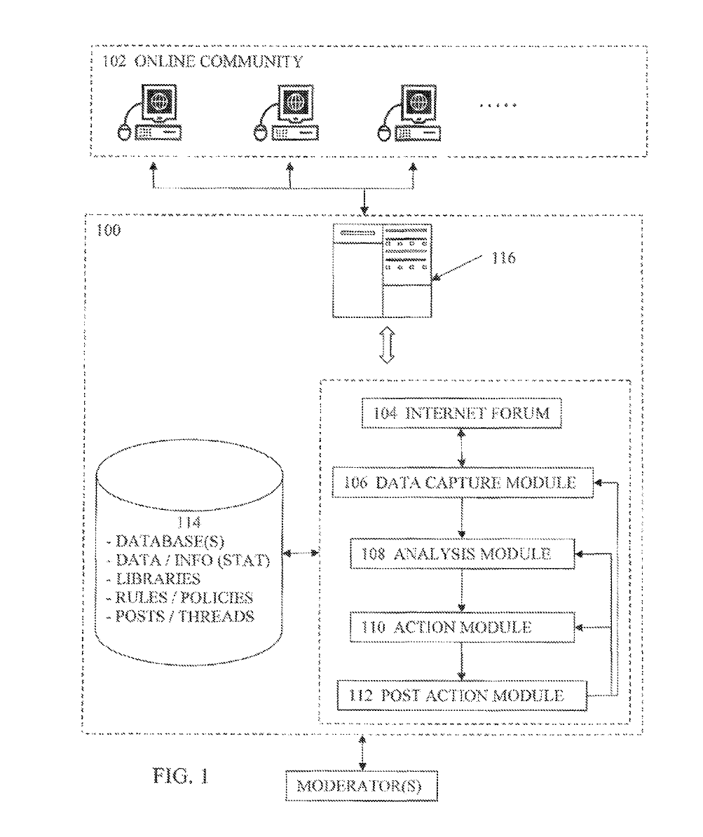

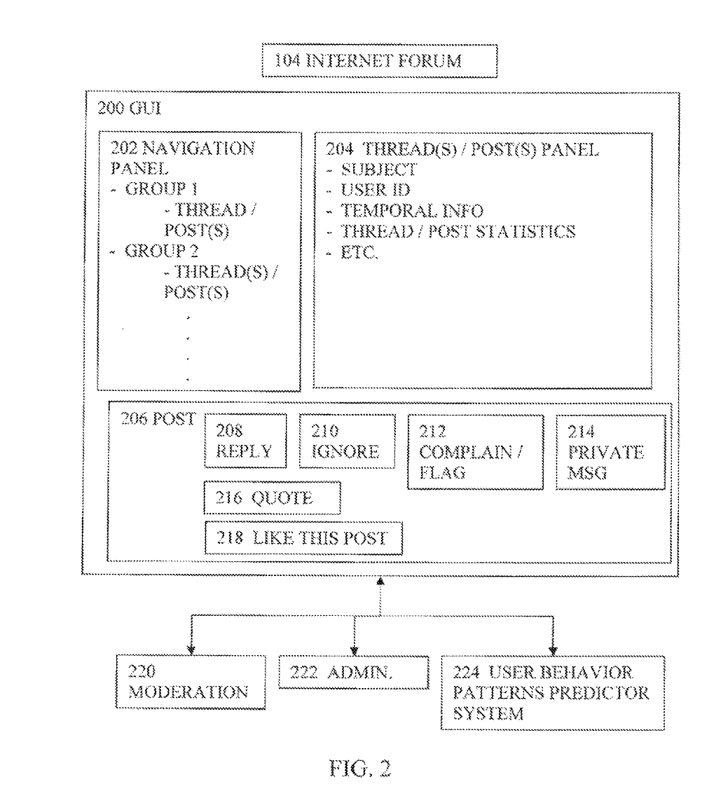

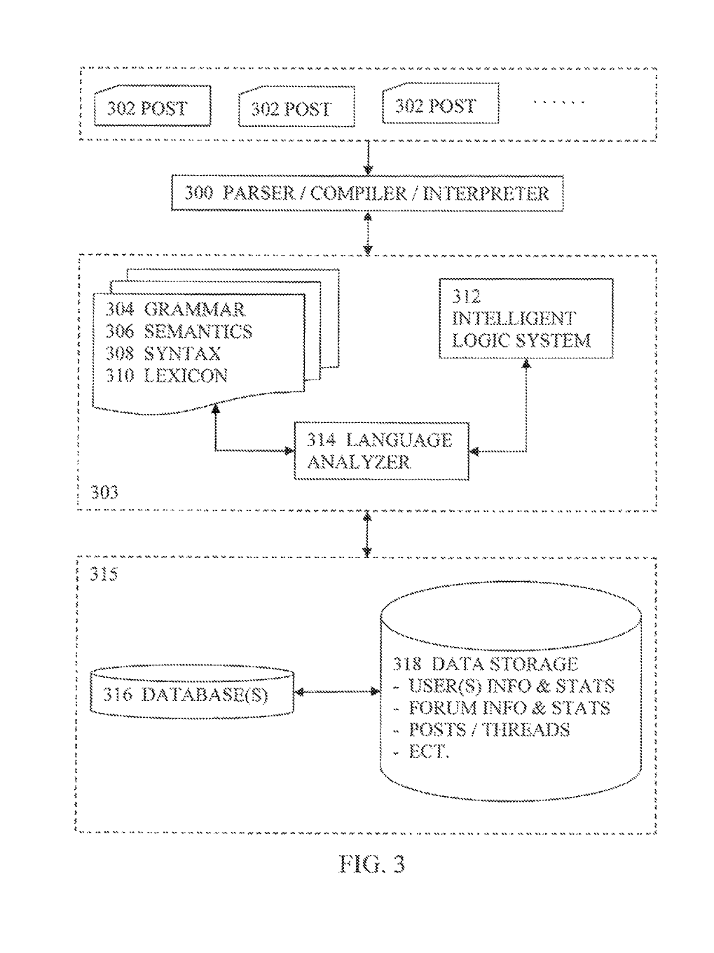

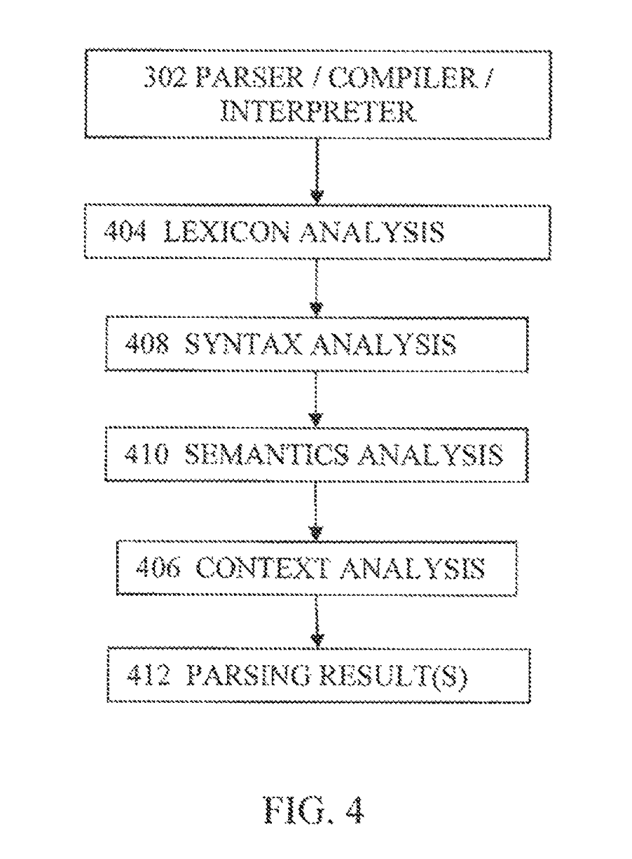

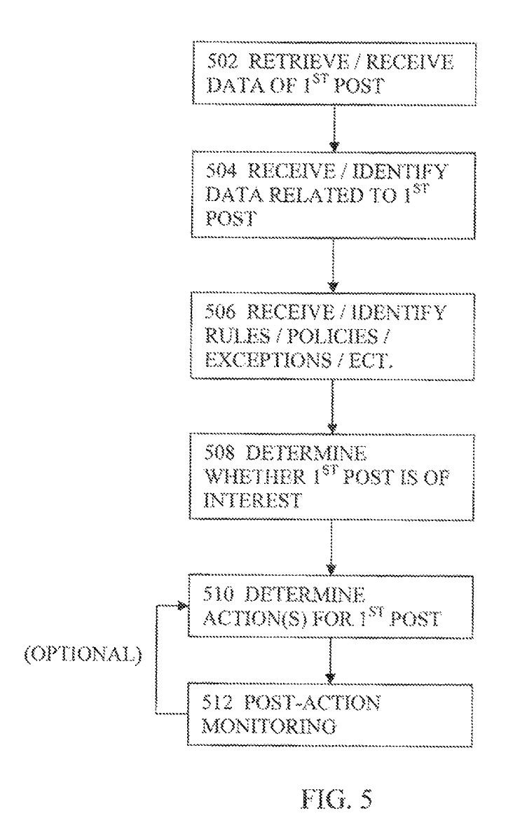

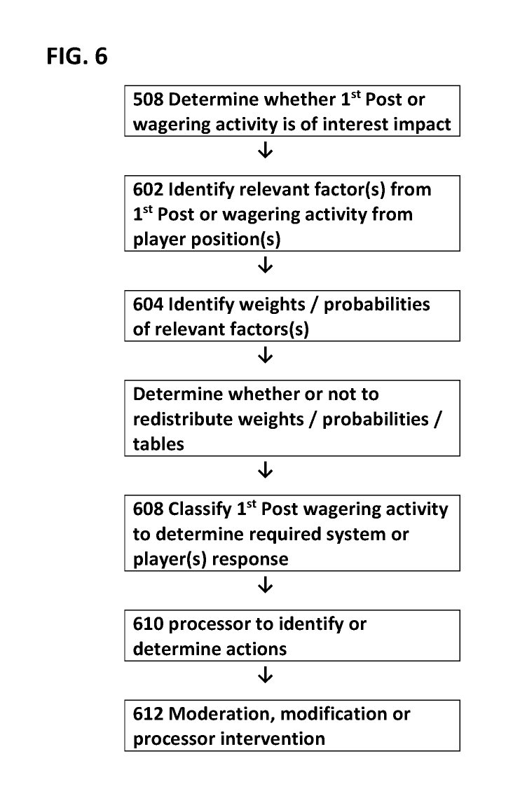

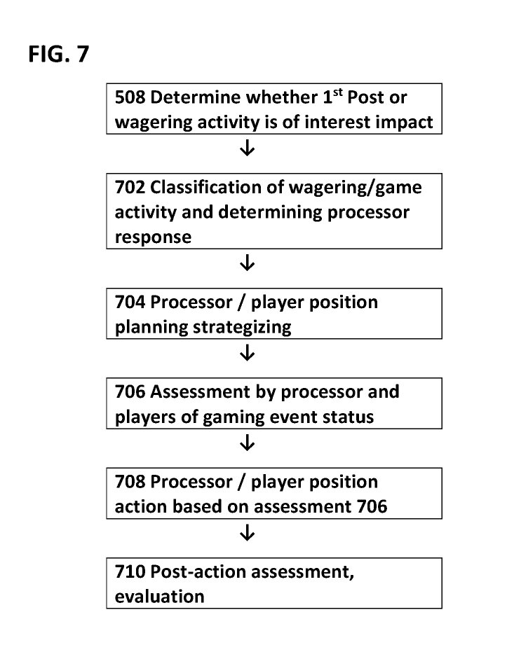

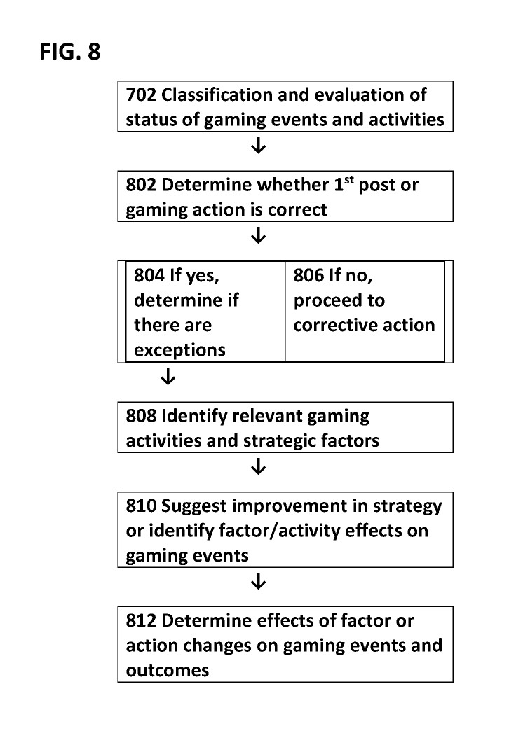

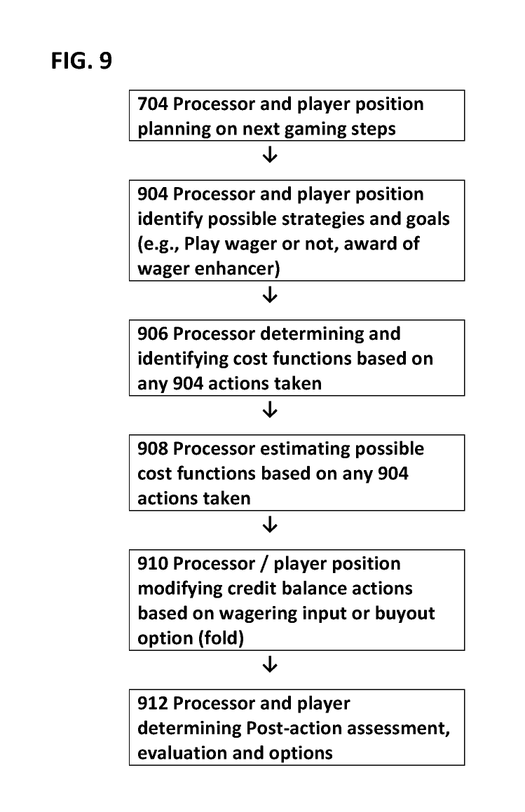

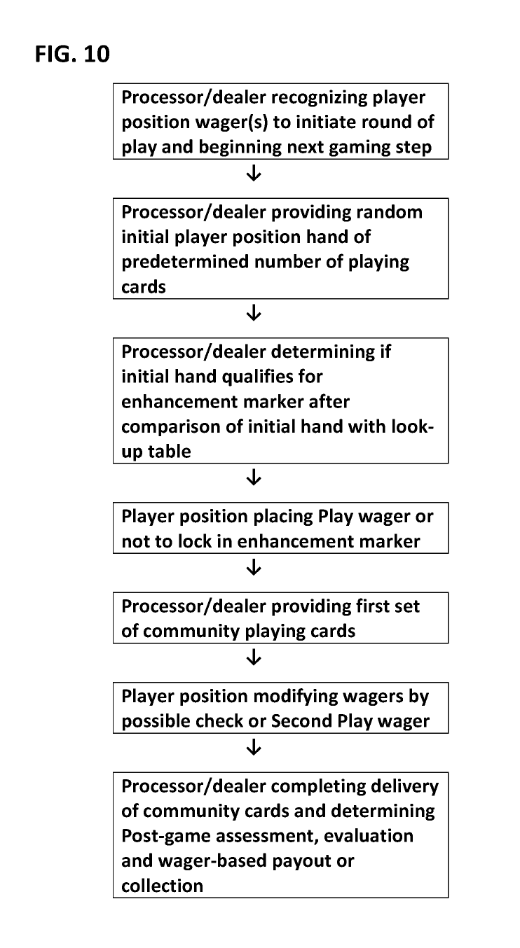

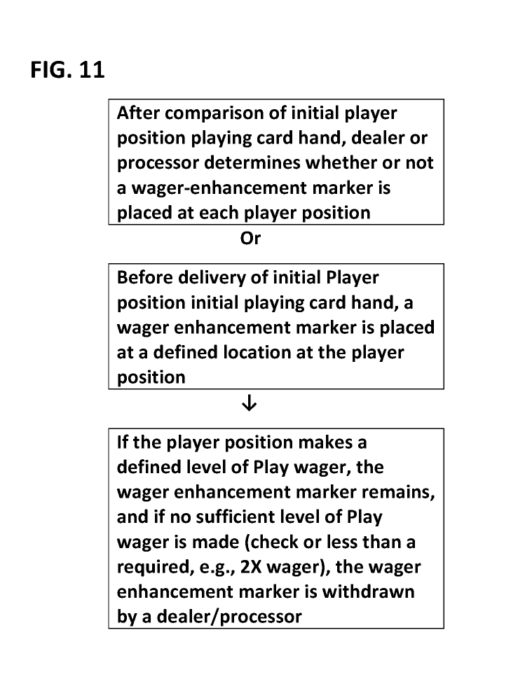

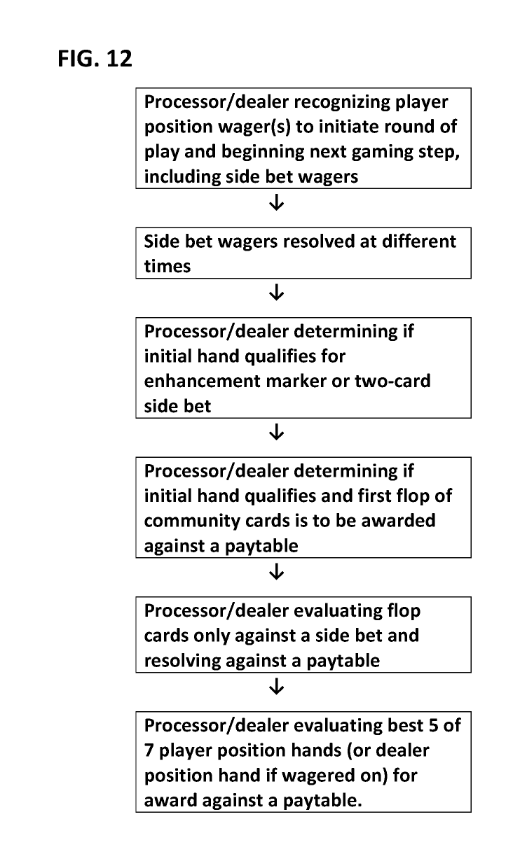

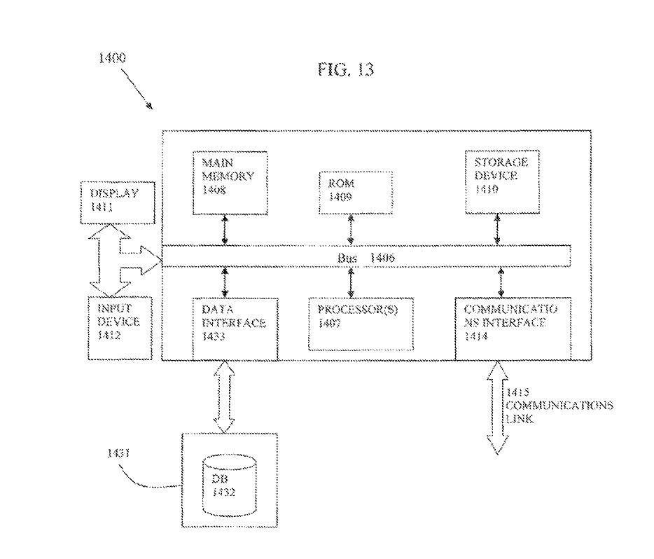

Turning next to FIG. 1, a video gaming machine 2 of the present invention is shown. Machine 2 includes a main cabinet 4, which generally surrounds the machine interior (not shown) and is viewable by users. The main cabinet includes a main door 8 on the front of the machine, which opens to provide access to the interior of the machine. Attached to the main door are player-input switches or buttons 32, a coin acceptor 28, and a bill validator 30, a coin tray 38, and a display area including a mechanical gaming system (or less preferably a separate electronic game) 40. There may be an overlay of touchscreen functionality on the separate electronic game 40 or some of the buttons 32 may be functional on the separate mechanical gaming system 40. That separate mechanical gaming system may be in a relatively vertical viewing position as shown, or in a more horizontal (table like) display unit. Viewable through the main door is a video display monitor 34 and an information panel 36. The display monitor 34 will typically be a cathode ray tube, high resolution flat-panel LCD, LED, plasma screen or other conventional electronically controlled video monitor. The information panel 36 may be a back-lit, silk screened glass panel with lettering to indicate general game information including, for example, a game denomination (e.g. $0.25 or $1). The bill validator 30, player-input switches 32, video display monitor 34, and information panel are devices used to play a game on the game machine 2. The devices are controlled by circuitry (e.g. the master gaming controller) housed inside the main cabinet 4 of the machine 2.

Many different types of games, including mechanical slot games, video slot games, video poker, video black jack, video pachinko and lottery, may be provided with gaming machines of this invention. In particular, the gaming machine 2 may be operable to provide a play of many different instances of games of chance. The instances may be differentiated according to themes, sounds, graphics, type of game (e.g., slot game vs. card game), denomination, number of paylines, maximum jackpot, progressive or non-progressive, bonus games, etc. The gaming machine 2 may be operable to allow a player to select a game of chance to play from a plurality of instances available on the gaming machine. For example, the gaming machine may provide a menu with a list of the instances of games that are available for play on the gaming machine and a player may be able to select from the list a first instance of a game of chance that they wish to play.

The various instances of games available for play on the gaming machine 2 may be stored as game software on a mass storage device in the gaming machine or may be generated on a remote gaming device but then displayed on the gaming machine. The gaming machine 2 may executed game software, such as but not limited to video streaming software that allows the game to be displayed on the gaming machine. When an instance is stored on the gaming machine 2, it may be loaded from the mass storage device into a RAM for execution. In some cases, after a selection of an instance, the game software that allows the selected instance to be generated may be downloaded from a remote gaming device, such as another gaming machine.

The gaming machine includes a top box 6, which sits on top of the main cabinet 4. The top box 6 houses a number of devices, which may be used to add features to a game being played on the gaming machine 2, including speakers 10, 12, 14, a ticket printer 18 which prints bar-coded tickets 20, a key pad 22 for entering player tracking information, a florescent display 16 for displaying player tracking information, a card reader 24 for entering a magnetic striped card containing player tracking information, and a video display screen 42. The ticket printer 18 may be used to print tickets for a cashless ticketing system. Further, the top box 6 may house different or additional devices than shown in the FIG. 1. For example, the top box may contain a bonus wheel or a back-lit silk-screened panel which may be used to add bonus features to the game being played on the gaming machine. As another example, the top box may contain a display for a progressive jackpot offered on the gaming machine. During a game, these devices are controlled and powered, in part, by circuitry (e.g. a master gaming controller) housed within the main cabinet 4 of the machine 2.

Understand that gaming machine 2 is but one example from a wide range of gaming machine designs on which the present invention may be implemented. For example, not all suitable gaming machines have top boxes or player tracking features. Further, some gaming machines have only a single game display mechanical or video, while others are designed for bar tables and have displays that face upwards. As another example, a game may be generated in on a host computer and may be displayed on a remote terminal or a remote gaming device. The remote gaming device may be connected to the host computer via a network of some type such as a local area network, a wide area network, an intranet or the Internet. The remote gaming device may be a portable gaming device such as but not limited to a cell phone, a personal digital assistant, and a wireless game player. Images rendered from 3-D gaming environments may be displayed on portable gaming devices that are used to play a game of chance. Further a gaming machine or server may include gaming logic for commanding a remote gaming device to render an image from a virtual camera in a 3-D gaming environments stored on the remote gaming device and to display the rendered image on a display located on the remote gaming device. Thus, those of skill in the art will understand that the present invention, as described below, can be deployed on most any gaming machine now available or hereafter developed.

Some preferred gaming machines are implemented with special features and/or additional circuitry that differentiates them from general-purpose computers (e.g., desktop PC's and laptops). Gaming machines are highly regulated to ensure fairness and, in many cases, gaming machines are operable to dispense monetary awards of multiple millions of dollars. Therefore, to satisfy security and regulatory requirements in a gaming environment, hardware and software architectures may be implemented in gaming machines that differ significantly from those of general-purpose computers. A description of gaming machines relative to general-purpose computing machines and some examples of the additional (or different) components and features found in gaming machines are described below.

At first glance, one might think that adapting PC technologies to the gaming industry would be a simple proposition because both PCs and gaming machines employ microprocessors that control a variety of devices. However, because of such reasons as 1) the regulatory requirements that are placed upon gaming machines, 2) the harsh environment in which gaming machines operate, 3) security requirements and 4) fault tolerance requirements, adapting PC technologies to a gaming machine can be quite difficult. Further, techniques and methods for solving a problem in the PC industry, such as device compatibility and connectivity issues, might not be adequate in the gaming environment. For instance, a fault or a weakness tolerated in a PC, such as security holes in software or frequent crashes, may not be tolerated in a gaming machine because in a gaming machine these faults can lead to a direct loss of funds from the gaming machine, such as stolen cash or loss of revenue when the gaming machine is not operating properly.

For the purposes of illustration, a few differences between PC systems and gaming systems will be described. A first difference between gaming machines and common PC based computers systems is that gaming machines are designed to be state-based systems. In a state-based system, the system stores and maintains its current state in a non-volatile memory, such that, in the event of a power failure or other malfunction the gaining machine will return to its current state when the power is restored. For instance, if a player was shown an award for a game of chance and, before the award could be provided to the player the power failed, the gaming machine, upon the restoration of power, would return to the state where the award is indicated. As anyone who has used a PC, knows, PCs are not state machines and a majority of data is usually lost when a malfunction occurs. This requirement affects the software and hardware design on a gaming machine.

A second important difference between gaming machines and common PC based computer systems is that for regulation purposes, the software on the gaming machine used to generate the game of chance and operate the gaming machine has been designed to be static and monolithic to prevent cheating by the operator of gaming machine. For instance, one solution that has been employed in the gaming industry to prevent cheating and satisfy regulatory requirements has been to manufacture a gaming machine that can use a proprietary processor running instructions to generate the game of chance from an EPROM or other form of non-volatile memory. The coding instructions on the EPROM are static (non-changeable) and must be approved by gaming regulators in a particular jurisdiction and installed in the presence of a person representing the gaming jurisdiction. Any changes to any part of the software required to generate the game of chance, such as adding a new device driver used by the master gaming controller to operate a device during generation of the game of chance can require a new EPROM to be burnt, approved by the gaming jurisdiction and reinstalled on the gaming machine in the presence of a gaming regulator. Regardless of whether the EPROM solution is used, to gain approval in most gaming jurisdictions, a gaming machine must demonstrate sufficient safeguards that prevent an operator or player of a gaming machine from manipulating hardware and software in a manner that gives them an unfair and some cases an illegal advantage. The gaming machine should have a means to determine if the code it will execute is valid. If the code is not valid, the gaming machine must have a means to prevent the code from being executed. The code validation requirements in the gaming industry affect both hardware and software designs on gaming machines.

A third important difference between gaming machines and common PC based computer systems is the number and kinds of peripheral devices used on a gaming machine are not as great as on PC based computer systems. Traditionally, in the gaming industry, gaming machines have been relatively simple in the sense that the number of peripheral devices and the number of functions the gaming machine has been limited. Further, in operation, the functionality of gaming machines were relatively constant once the gaming machine was deployed, i.e., new peripherals devices and new gaming software were infrequently added to the gaming machine. This differs from a PC where users will go out and buy different combinations of devices and software from different manufacturers and connect them to a PC to suit their needs depending on a desired application. Therefore, the types of devices connected to a PC may vary greatly from user to user depending in their individual requirements and may vary significantly over time.

Although the variety of devices available for a PC may be greater than on a gaming machine, gaming machines still have unique device requirements that differ from a PC, such as device security requirements not usually addressed by PCs. For instance, monetary devices, such as coin dispensers, bill validators and ticket printers and computing devices that are used to govern the input and output of cash to a gaming machine have security requirements that are not typically addressed in PCs. Therefore, many PC techniques and methods developed to facilitate device connectivity and device compatibility do not address the emphasis placed on security in the gaming industry.

To address some of the issues described above, a number of hardware/software components and architectures are utilized in gaming machines that are not typically found in general purpose computing devices, such as PCs. These hardware/software components and architectures, as described below in more detail, include but are not limited to watchdog timers, voltage monitoring systems, state-based software architecture and supporting hardware, specialized communication interfaces, security monitoring and trusted memory.

A watchdog timer is normally used in gaming machines to provide a software failure detection mechanism. In a normally operating system, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits contain a loadable timeout counter register to allow the operating software to set the timeout interval within a certain range of time. A differentiating feature of some preferred circuits is that the operating software cannot completely disable the function of the watchdog timer. In other words, the watchdog timer always functions from the time power is applied to the board.

Gaming computer platforms preferably use several power supply voltages to operate portions of the computer circuitry. These can be generated in a central power supply or locally on the computer board. If any of these voltages falls out of the tolerance limits of the circuitry they power, unpredictable operation of the computer may result. Though most modem general-purpose computers include voltage monitoring circuitry, these types of circuits only report voltage status to the operating software. Out of tolerance voltages can cause software malfunction, creating a potential uncontrolled condition in the gaming computer. Gaming machines typically have power supplies with tighter voltage margins than that required by the operating circuitry. In addition, the voltage monitoring circuitry implemented in gaming computers typically has two thresholds of control. The first threshold generates a software event that can be detected by the operating software and an error condition generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the computer.

The standard method of operation for slot machine game software is to use a state machine. Different functions of the game (bet, play, result, points in the graphical presentation, etc.) may be defined as a state. When a game moves from one state to another, critical data regarding the game software is stored in a custom non-volatile memory subsystem. This is critical to ensure the player's wager and credits are preserved and to minimize potential disputes in the event of a malfunction on the gaming machine.

In general, the gaming machine does not advance from a first state to a second state until critical information that allows the first state to be reconstructed is stored. This feature allows the game to recover operation to the current state of play in the event of a malfunction, loss of power, etc. that occurred just prior to the malfunction. After the state of the gaming machine is restored during the play of a game of chance, game play may resume and the game may be completed in a manner that is no different than if the malfunction had not occurred. Typically, battery backed RAM devices are used to preserve this critical data although other types of non-volatile memory devices may be employed. These memory devices are not used in typical general-purpose computers.

As described in the preceding paragraph, when a malfunction occurs during a game of chance, the gaming machine may be restored to a state in the game of chance just prior to when the malfunction occurred. The restored state may include metering information and graphical information that was displayed on the gaming machine in the state prior to the malfunction. For example, when the malfunction occurs during the play of a card game after the cards have been dealt, the gaming machine may be restored with the cards that were previously displayed as part of the card game. As another example, a bonus game may be triggered during the play of a game of chance where a player is required to make a number of selections on a video display screen. When a malfunction has occurred after the player has made one or more selections, the gaming machine may be restored to a state that shows the graphical presentation at the just prior to the malfunction including an indication of selections that have already been made by the player. In general, the gaming machine may be restored to any state in a plurality of states that occur in the game of chance that occurs while the game of chance is played or to states that occur between the play of a game of chance.

Game history information regarding previous games played such as an amount wagered, the outcome of the game and so forth may also be stored in a non-volatile memory device. The information stored in the non-volatile memory may be detailed enough to reconstruct a portion of the graphical presentation that was previously presented on the gaming machine and the state of the gaming machine (e.g., credits) at the time the game of chance was played. The game history information may be utilized in the event of a dispute. For example, a player may decide that in a previous game of chance that they did not receive credit for an award that they believed they won. The game history information may be used to reconstruct the state of the gaming machine prior, during and/or after the disputed game to demonstrate whether the player was correct or not in their assertion.

Another feature of gaming machines, such as gaming computers, is that they often contain unique interfaces, including serial interfaces, to connect to specific subsystems internal and external to the slot machine. The serial devices may have electrical interface requirements that differ from the “standard” EIA 232 serial interfaces provided by general-purpose computers. These interfaces may include EIA 485, EIA 422, Fiber Optic Serial, optically coupled serial interfaces, current loop style serial interfaces, etc. In addition, to conserve serial interfaces internally in the slot machine, serial devices may be connected in a shared, daisy-chain fashion, where multiple peripheral devices are connected to a single serial channel.

The serial interfaces may be used to transmit information using communication protocols that are unique to the gaming industry. For example, the Netplex™ system of IGT is a proprietary communication protocol used for serial communication between gaming devices. As another example, SAS is a communication protocol used to transmit information, such as metering information, from a gaming machine to a remote device. Often SAS is used in conjunction with a player tracking system.

Gaming machines may alternatively be treated as peripheral devices to a casino communication controller and connected in a shared daisy chain fashion to a single serial interface. In both cases, the peripheral devices are preferably assigned device addresses. If so, the serial controller circuitry must implement a method to generate or detect unique device addresses. General-purpose computer serial ports are not able to do this.

Security monitoring circuits detect intrusion into a gaming machine by monitoring security switches attached to access doors in the slot machine cabinet. Preferably, access violations result in suspension of game play and can trigger additional security operations to preserve the current state of game play. These circuits also function when power is off by use of a battery backup. In power-off operation, these circuits continue to monitor the access doors of the slot machine. When power is restored, the gaming machine can determine whether any security violations occurred while power was off, e.g., via software for reading status registers. This can trigger event log entries and further data authentication operations by the slot machine software.

Trusted memory devices are preferably included in a gaming machine computer to ensure the authenticity of the software that may be stored on less secure memory subsystems, such as mass storage devices. Trusted memory devices and controlling circuitry are typically designed to not allow modification of the code and data stored in the memory device while the memory device is installed in the slot machine. The code and data stored in these devices may include authentication algorithms, random number generators, authentication keys, operating system kernels, etc. The purpose of these trusted memory devices is to provide gaming regulatory authorities a root trusted authority within the computing environment of the slot machine that can be tracked and verified as original. This may be accomplished via removal of the Misted memory device from the slot machine computer and verification of the secure memory device contents is a separate third party verification device. Once the trusted memory device is verified as authentic, and based on the approval of the verification algorithms contained in the trusted device, the gaming machine is allowed to verify the authenticity of additional code and data that may be located in the gaming computer assembly, such as code and data stored on hard disk drives. A few details related to trusted memory devices that may be used in the present invention are described in U.S. Pat. No. 6,685,567 titled “Process Verification,” which is incorporated herein in its entirety and for all purposes.

Mass storage devices used in a general purpose computer typically allow code and data to be read from and written to the mass storage device. In a gaming machine environment, modification of the gaming code stored on a mass storage device is strictly controlled and would only be allowed under specific maintenance type events with electronic and physical enablers required. Though this level of security could be provided by software, gaming computers that include mass storage devices preferably include hardware level mass storage data protection circuitry that operates at the circuit level to monitor attempts to modify data on the mass storage device and will generate both software and hardware error triggers should a data modification be attempted without the proper electronic and physical enablers being present.

Returning to the example of FIG. 1, when a user wishes to play the gaming machine 2, he or she inserts cash through the coin acceptor 28 or bill validator 30. Additionally, the bill validator may accept a printed ticket voucher which may be accepted by the bill validator 30 as an indicia of credit when a cashless ticketing system is used. At the start of the game, the player may enter playing tracking information using the card reader 24, the keypad 22, and the florescent display 16. Further, other game preferences of the player playing the game may be read from a card inserted into the card reader. During the game, the player views game information using the video display 34. Other game and prize information may also be displayed in the video display screen 42 located in the top box.

During the course of a game, a player may be required to make a number of decisions, which affect the outcome of the game. For example, a player may vary, his or her wager on a particular game, select a prize for a particular game selected from a prize server, or make game decisions which affect the outcome of a particular game. The player may make these choices using the player-input switches 32, the video display screen 34 or using some other device which enables a player to input information into the gaming machine. In some embodiments, the player may be able to access various game services such as concierge services and entertainment content services using the video display screen 34 and one more input devices.

During certain game events, the gaming machine 2 may display visual and auditory effects that can be perceived by the player. These effects add to the excitement of a game, which makes a player more likely to continue playing. Auditory effects include various sounds that are projected by the speakers 10, 12, 14. Visual effects include flashing lights, strobing lights or other patterns displayed from lights on the gaming machine 2 or from lights within the separate mechanical (or electronic) separately, individually wagerable gaming system 40. After the player has completed a game, the player may receive game tokens from the coin tray 38 or the ticket 20 from the printer 18, which may be used for further games or to redeem a prize. Further, the player may receive a ticket 20 for food, merchandise, or games from the printer 18.

Another gaming network that may be used to implement some aspects of the invention is depicted in FIG. 1A. Gaming establishment 1001 could be any sort of gaming establishment, such as a casino, a card room, an airport, a store, etc. In this example, gaming network 1077 includes more than one gaming establishment, all of which are networked to game server 1022.

Here, gaming machine 1002, and the other gaming machines 1030, 1032, 1034, and 1036, include a main cabinet 1006 and a top box 1004. The main cabinet 1006 houses the main gaming elements and can also house peripheral systems, such as those that utilize dedicated gaming networks. The top box 1004 may also be used to house these peripheral systems.

The master gaming controller 1008 controls the game play on the gaming machine 1002 according to instructions and/or game data from game server 1022 or stored within gaming machine 1002 and receives or sends data to various input/output devices 1011 on the gaming machine 1002. In one embodiment, master gaming controller 1008 includes processor(s) and other apparatus of the gaming machines described above. The master gaming controller 1008 may also communicate with a display 1010.

A particular gaming entity may desire to provide network gaming services that provide some operational advantage. Thus, dedicated networks may connect gaming machines to host servers that track the performance of gaming machines under the control of the entity, such as for accounting management, electronic fund transfers (EFTs), cashless ticketing, such as EZPay™, marketing management, and data tracking, such as player tracking. Therefore, master gaming controller 1008 may also communicate with EFT system 1012, EZPay™ system, and player tracking system 1020. The systems of the gaming machine 1002 communicate the data onto the network 1022 via a communication board 1018.

It will be appreciated by those of skill in the art that embodiments of the present invention could be implemented on a network with more or fewer elements than are depicted in FIG. 1A. For example, player tracking system 1020 is not a necessary feature of some implementations of the present invention. However, player tracking programs may help to sustain a game player's interest in additional game play during a visit to a gaming establishment and may entice a player to visit a gaming establishment to partake in various gaming activities. Player tracking programs provide rewards to players that typically correspond to the player's level of patronage (e.g., to the player's playing frequency and/or total amount of game plays at a given casino). Player tracking rewards may be free meals, free lodging and/or free entertainment. Player tracking information may be combined with other information that is now readily obtainable by an SBG system.

Moreover, DCU 1024 and translator 1025 are not required for all gaming establishments 1001. However, due to the sensitive nature of much of the information on a gaming network (e.g., electronic fund transfers and player tracking data) the manufacturer of a host system usually employs a particular networking language having proprietary protocols. For instance, 10-20 different companies produce player tracking host systems where each host system may use different protocols. These proprietary protocols are usually considered highly confidential and not released publicly.

Further, gaming machines are made by many different manufacturers. The communication protocols on the gaming machine are typically hard-wired into the gaming machine and each gaming machine manufacturer may utilize a different proprietary communication protocol. A gaming machine manufacturer may also produce host systems, in which case their gaming machines are compatible with their own host systems. However, in a heterogeneous gaming environment, gaming machines from different manufacturers, each with its own communication protocol, may be connected to host systems from other manufacturers, each with another communication protocol. Therefore, communication compatibility issues regarding the protocols used by the gaming machines in the system and protocols used by the host systems must be considered.

A network device that links a gaming establishment with another gaming establishment and/or a central system will sometimes be referred to herein as a “site controller.” Here, site controller 1042 provides this function for gaming establishment 1001. Site controller 1042 is connected to a central system and/or other gaming establishments via one or more networks, which may be public or private networks. Among other things, site controller 1042 communicates with game server 1022 to obtain game data, such as ball drop data, bingo card data, etc.

In the present illustration, gaming machines 1002, 1030, 1032, 1034 and 1036 are connected to a dedicated gaming network 1022. In general, the DCU 1024 functions as an intermediary between the different gaming machines on the network 1022 and the site controller 1042. In general, the DCU 1024 receives data transmitted from the gaming machines and sends the data to the site controller 1042 over a transmission path 1026. In some instances, when the hardware interface used by the gaming machine is not compatible with site controller 1042, a translator 1025 may be used to convert serial data from the DCU 1024 to a format accepted by site controller 1042. The translator may provide this conversion service to a plurality of DCUs.

Further, in some dedicated gaming networks, the DCU 1024 can receive data transmitted from site controller 1042 for communication to the gaming machines on the gaming network. The received data may be, for example, communicated synchronously to the gaming machines on the gaming network.

Here, CVT 1052 provides cashless and cashout gaming services to the gaming machines in gaming establishment 1001. Broadly speaking, CVT 1052 authorizes and validates cashless gaming machine instruments (also referred to herein as “tickets” or “vouchers”), including but not limited to tickets for causing a gaming machine to display a game result and cash-out tickets. Moreover, CVT 1052 authorizes the exchange of a cashout ticket for cash. These processes will be described in detail below. In one example, when a player attempts to redeem a cash-out ticket for cash at cashout kiosk 1044, cash out kiosk 1044 reads validation data from the cashout ticket and transmits the validation data to CVT 1052 for validation. The tickets may be printed by gaming machines, by cashout kiosk 1044, by a stand-alone printer, by CVT 1052, etc. Some gaming establishments will not have a cashout kiosk 1044. Instead, a cashout ticket could be redeemed for cash by a cashier (e.g. of a convenience store), by a gaming machine or by a specially configured CVT.

FIG. 1B illustrates an example of a network device that may be configured for implementing some methods of the present invention. Network device 1160 includes a master central processing unit (CPU) 1162, interfaces 1168, and a bus 1167 (e.g., a PCI bus). Generally, interfaces 1168 include ports 1169 appropriate for communication with the appropriate media. In some embodiments, one or more of interfaces 1168 includes at least one independent processor and, in some instances, volatile RAM. The independent processors may be, for example, ASICs or any other appropriate processors. According to some such embodiments, these independent processors perform at least some of the functions of the logic described herein. In some embodiments, one or more of interfaces 1168 control such communications-intensive tasks as encryption, decryption, compression, decompression, packetization, media control and management. By providing separate processors for the communications-intensive tasks, interfaces 1168 allow the master microprocessor 1162 efficiently to perform other functions such as routing computations, network diagnostics, security functions, etc.

The interfaces 1168 are typically provided as interface cards (sometimes referred to as “linecards”). Generally, interfaces 1168 control the sending and receiving of data packets over the network and sometimes support other peripherals used with the network device 1160. Among the interfaces that may be provided are FC interfaces, Ethernet interfaces, frame relay interfaces, cable interfaces, DSL interfaces, token ring interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like.

When acting under the control of appropriate software or firmware, in some implementations of the invention CPU 1162 may be responsible for implementing specific functions associated with the functions of a desired network device. According to some embodiments, CPU 1162 accomplishes all these functions under the control of software including an operating system and any appropriate applications software.

CPU 1162 may include one or more processors 1163 such as a processor from the Motorola family of microprocessors or the MIPS family of microprocessors. In an alternative embodiment, processor 1163 is specially designed hardware for controlling the operations of network device 1160. In a specific embodiment, a memory 1161 (such as non-volatile RAM and/or ROM) also forms part of CPU 1162. However, there are many different ways in which memory could be coupled to the system. Memory block 1161 may be used for a variety of purposes such as, for example, caching and/or storing data, programming instructions, etc.

Regardless of network device's configuration, it may employ one or more memories or memory modules (such as, for example, memory block 1165) configured to store data, program instructions for the general-purpose network operations and/or other information relating to the functionality of the techniques described herein. The program instructions may control the operation of an operating system and/or one or more applications, for example.

Because such information and program instructions may be employed to implement the systems/methods described herein, the present invention also relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media; and hardware devices that are specially configured to store and perform program instructions, such as read-only memory devices (ROM) and random access memory (RAM). The invention may also be embodied in a carrier wave traveling over an appropriate medium such as airwaves, optical lines, electric lines, etc. Examples of program instructions include both machine code, such as produced by a compiler, and files containing higher-level code that may be executed by the computer using an interpreter.

Although the system shown in FIG. 1B illustrates one specific network device of the present invention, it is by no means the only network device architecture on which the present invention can be implemented. For example, an architecture having a single processor that handles communications as well as routing computations, etc. is often used. Further, other types of interfaces and media could also be used with the network device. The communication path between interfaces may be bus based (as shown in FIG. 1B) or switch fabric based (such as a cross-bar).

The present technology may also be executed as a game event in which a winner is declared among at least two players either for the honor and pride in winning or as an event to establish priority towards advancing in an event or attaining entry to an event or obtaining a prize of little, no, or inconsequential value, such as a ribbon or medal. Such a method could be generally described as a method of executing a competitive game event in a player versus player competition using at least one standard randomized deck of playing cards, the method comprising:
a) providing a source of random playing card symbols, the source including at least symbols of at least one deck of playing cards;
b) at least two player positions competing in a game event in which the at least two player positions are provided with random playing card symbols at respective player positions and in a stream of community cards in an attempt to collect point counts at the respective player positions closest to a point count of 21 without exceeding a point count of 21;
c) providing at least one random playing card symbol from the at least one deck of playing card symbols to each of the at least two player positions having placed value at risk as an ante wager;
d) an ordered number of random playing card symbols is provided from the at least one randomized deck of playing card symbols to a community card location in a position order of at least a first playing card symbol, a second playing card symbol, and a third playing card symbol until a specific predetermined number of random playing card symbols have been provided or the point count total of all exposed playing card symbols in the community card location equals or exceeds a point count total of 19;
e) point count totals in each of the at least two player positions are determined according to a specific point count procedure consisting of totaling count points for all playing card symbols in respective ones of the at least two player positions and then adding point counts from individual ones of the playing card symbols in the community card location in their position order up to a maximum point count total of 21 or less, without exceeding a total point count of 21;
f) each of the at least two player positions comparing respective point count totals at respective player positions;
g) determining which respective player position has a point count total closest to 21 without exceeding 21;
h) if respective point count totals are equal, counting total numbers of playing card symbols in respective player position hands; and
i) then declaring a player position hands as a winning hand that has a point count total closest to 21 without exceeding 21 and has a largest number of total playing card symbols when respective point count totals are equal.

The method can be implemented by all playing card symbols being provided by physical playing cards randomly provided to each respective player position, as where each physical playing cards is provided from a randomized set of at least one fifty-two card deck of physical playing cards, as from a dealer shoe, or shuffling machine tray. Electromechanical shuffling machines such as those produced by Shufflemaster, Inc, Division of Bally Industries within Scientific Games Incorporated are well suited for this method of providing physical playing cards, as are the mechanical dealing trays, passive dealing trays, and preshuffled dealing trays as known in the art. The games may also be played person-versus-person on networked or linked personal data entry devices such as smart phones, tablets, laptops, and other smart player-user electronic devices with visual displays and player input controls and interconnectivity through a gaming processor to monitor game play, as with an internet provider or central gaming server/processor. If there is an identical winning point count total in multiple ones of the at least two player positions, a player position which utilizes a most number of playing cards in attaining that winning point count total wins. Similarly, ties are broken to determine a winning hand by identifying a player using the playing cards in

The gaming event may be played on electronic gaming tables, or mixed technology gaming tables. Such technology as disclosed in U.S. Pat. No. 9,721,421 (Blazevic); U.S. Pat. No. 7,264,243 (Yoseloff); U.S. Pat. No. 7,556,561 (White); U.S. Pat. No. 7,699,695 (White); U.S. Pat. No. 7,794,324 (White); U.S. patent application Ser. Nos. 10/864,051; 10/764,995; 10/764,827; and 10/764,994 (Smith et al.). These references are incorporated by reference in their entirety, enabling use of the present gaming technology on electronically implemented gaming tables in which there are respective player positions, individual player input controls, individual player terminals with video displays, a central gaming processor and random number generator that provides random displays of randomly provided playing cards at player (and where needed, dealer) positions, determines wagers and community pots, can withdraw house commissions, and determine winning outcomes and distribute and withdraw value. As noted, the art enables both partially electronic tables, as where physical playing cards are used with a dealer distributing them, but with wagers being made electronically as with the DEQ Platinum Plus™ betting system or its equivalent, player terminals having crediting, accounting and wagering functions thereon (as with TITO systems, currency validators, eWallet responsive systems, and the like.

Fully electronic systems, as described above and known in the art may also be used.

What is claimed:

1. A method of executing a wagering event in a player versus player wagering event supported by a non-wagering third party using at least one standard randomized deck of playing cards, the method comprising:
a) providing at least one randomized deck of playing cards;
b) at least two player positions placing value at risk as an ante wager, blind wager or both ante wager and blind wager into a community pot on an outcome of a wagering event in which the at least two player positions are provided with random playing cards at respective player positions from a stream of community cards, or from individual cards dealt to each player consecutively from the at least one standard randomized deck of playing cards to collect point counts at the respective player positions closest to a point count of 21 without exceeding a point count of 21;
c) providing at least one random playing card from the at least one randomized deck of playing cards to each of the at least two player positions having placed value at risk as an ante wager;
d) each of the at least two player positions making a first play wager into the community pot to continue play at the at least two player positions;
e) if only one player position makes the first play wager or any subsequent play wager, that one player collects the community pot;
f) if multiple ones of the at least two player positions make the first play wager, then an ordered number of random playing cards is provided from the at least one randomized deck of playing cards to a community card location or individual player location in a position order of at least a first playing card, a second playing card, and a third playing card until a specific predetermined number of random playing cards have been provided or the point count total of all exposed playing cards in the community card location equals or exceeds a point count total of 19;
g) point count totals in each of the at least two player positions are determined according to a specific point count procedure consisting of totaling count points for all cards in respective ones of the at least two player positions and then adding point counts from individual ones of the playing cards in the community card location in their position order up to a maximum point count total of 21 or less, without exceeding a total point count of 21;
h) each of the at least two player positions comparing respective point count totals at respective player positions;
i) determining which respective player position has a point count total closest to 21 without exceeding 21; and
j) then awarding the community pot to that respective player position that has a point count total closest to 21 without exceeding 21.

2) The method of claim 1 wherein the at least one random playing card from the at least one randomized deck of playing cards to each of the at least two player positions consists of exactly two random playing cards face down, or face up, or one face up and the other face down to the at least two player positions.

3) The method of claim 2 wherein the at least the first playing card, and the second playing card are provided one playing card at a time.

4) The method of claim 2 wherein the at least the first playing card, and the second playing card are provided as a set of two playing cards.

5) The method of claim 2 wherein after each random playing card or groups of random playing cards is provided from the at least one randomized deck of playing cards to the community card location in the position order, a play wager is placed at each of the at least two player positions, and a player position failing to make a play wager is withdrawn from the wagering event.

6) The method of claim 5 wherein placing of play wagers or not at each of the two player positions is performed contemporaneously and not sequentially.

7) The method of claim 6 where a no-bet marker is placed at a player position when a player position is not placing a play wager, and the no-bet marker is revealed contemporaneously with disclosure at another of the at least two player positions of a play wager or a non-bet wager at the another of the at least two player positions.

8) The method of claim 7 wherein if all of the at least two player positions place no-bet wagers, all players most recently placing the no-bet wager split the community pot.

9) The method of claim 6 wherein contemporaneous display of placing play wagers or not is executed by player input entered into an electronic wagering control at each of the at least two wagering positions, and when all of the at least two player positions have entered the play wagers or not, all player wager input is revealed to all of the at least two player positions.

10) The method of claim 1 wherein when at least two player positions have an identical point count total, a player position using a most number of total playing cards including all of the at least one random playing card at a respective player position and the ordered number of random playing cards provided in forming that identical point count total wins the community pot.

11) The method of claim 11 wherein if a same number of playing cards is used in forming that identical point count total by the at least two players, the community pot is equally split among players having the same number of playing cards used in forming that identical point count total.

12) The method of claim 1 wherein each player position is an electronic player input terminal, all randomized playing cards are virtual playing cards displayed on a screen by a game processor in communication with each electronic player input terminal, and each player input terminal comprises a value-in-value-out components selected from the group consisting of e-Wallet systems embedded in the electronic player input terminal in communication with the game processor, ticket-in-ticket-out systems with a ticket reader and printer, and a currency validator with a drive motor for receiving and expelling currency.

13) The method of claim 1 wherein if there is an identical winning point count total in multiple ones of the at least two player positions, a player position which utilizes a most number of playing cards in attaining that winning point count total wins the community pot.

14) The method of claim 2 wherein if there is an identical winning point count total in multiple ones of the at least two player positions, a player position which utilizes a most number of playing cards in attaining that winning point count total wins the community pot.

15) The method of claim 1 wherein ties are broken by a winning hand being determined by identifying a player using the most playing cards in reaching a final point count total.

16) The method of claim 1 wherein ties are broken by a winning hand being determined by identifying a player using the playing cards in forming a highest poker rank using all players in a final point count total hand.

17) A method of executing a competitive game event in a player versus player competition using at least one standard randomized deck of playing cards, the method comprising:
a) providing a source of random playing card symbols, the source including at least symbols of at least one deck of playing cards;
b) at least two player positions competing in a game event in which the at least two player positions are provided with random playing card symbols at respective player positions and in a stream of community cards in an attempt to collect point counts at the respective player positions closest to a point count of 21 without exceeding a point count of 21;
c) providing at least one random playing card symbol from the at least one deck of playing card symbols to each of the at least two player positions having placed value at risk as an ante wager;
d) an ordered number of random playing card symbols is provided from the at least one randomized deck of playing card symbols to a community card location in a position order of at least a first playing card symbol, a second playing card symbol, and a third playing card symbol until a specific predetermined number of random playing card symbols have been provided or the point count total of all exposed playing card symbols in the community card location equals or exceeds a point count total of 19;
e) point count totals in each of the at least two player positions are determined according to a specific point count procedure consisting of totaling count points for all playing card symbols in respective ones of the at least two player positions and then adding point counts from individual ones of the playing card symbols in the community card location in their position order up to a maximum point count total of 21 or less, without exceeding a total point count of 21;
f) each of the at least two player positions comparing respective point count totals at respective player positions;
g) determining which respective player position has a point count total closest to 21 without exceeding 21;
h) if respective point count totals are equal, counting total numbers of playing card symbols in respective player position hands; and
i) then declaring a player position hands as a winning hand that has a point count total closest to 21 without exceeding 21 and has a largest number of total playing card symbols when respective point count totals are equal.

18) The method of claim 17 wherein all playing card symbols are provided by physical playing cards randomly provided to each respective player position.

19) The method of claim 18 wherein each physical playing cards is provided from a randomized set of at least one fifty-two card deck of physical playing cards.

20) The method of claim 17 wherein if there is an identical winning point count total in multiple ones of the at least two player positions, a player position which utilizes a most number of playing cards in attaining that winning point count total wins.

21) The method of claim 1 wherein ties are broken to determine a winning hand by identifying a player using the playing cards in forming a highest poker rank using all players in a final point count total hand.

22) A method of executing a wagering event in a player versus player wagering event supported by a non-wagering third party using at least one standard randomized deck of playing cards, the method comprising:
a) providing at least one randomized deck of playing cards;
b) at least two player positions placing value at risk as an ante wager, blind wager or both ante wager and blind wager into a community pot on an outcome of a wagering event in which the at least two player positions are provided with random playing cards at respective player positions from a stream of community cards, or from individual cards dealt to each player consecutively from the at least one standard randomized deck of playing cards to collect point counts at the respective player positions closest to a specific predetermined point count of X without exceeding a point count of X as determined by adding individual point count totals where each of a 10, Jack, Queen and King equals 10 points, an Ace is 2 or 11, and every other card has its shown point count value;
c) providing at least one random playing card from the at least one randomized deck of playing cards to each of the at least two player positions having placed value at risk as an ante wager;
d) each of the at least two player positions making a first play wager into the community pot to continue play at the at least two player positions;
e) if only one player position makes the first play wager or any subsequent play wager, that one player collects the community pot;
f) if multiple ones of the at least two player positions make the first play wager, then an ordered number of random playing cards is provided from the at least one randomized deck of playing cards to a community card location in a position order of at least a first playing card, a second playing card, and a third playing card until a specific predetermined number of random playing cards have been provided or the point count total of all exposed playing cards in the community card location equals or exceeds a point count total of X-2;
g) point count totals in each of the at least two player positions are determined according to a specific point count procedure consisting of totaling count points for all cards in respective ones of the at least two player positions and then adding point counts from individual ones of the playing cards in the community card location in their position order up to a maximum point count total of X or less, without exceeding a total point count of X;
h) each of the at least two player positions comparing respective point count totals at respective player positions;
i) determining which respective player position has a point count total closest to X without exceeding X; and
j) then awarding the community pot to that respective player position that has a point count total closest to X without exceeding X.
